(19) United States
(12) Patent Application Publication
(10) Pub. No.: US 2007/0052945 A1
(43) Pub. Date: Mar. 8, 2007

(54) Method and apparatus for protecting a reticle used in chip production from contamination

(75) Inventors: Marinus Antonius Dimphna Maria Loos, Eindhoven (NL); Rudolf Maria Jozef Voncken, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/572,470

(22) PCT Filed: Sep. 16, 2004
(86) PCT No.: PCT/IB04/51774

§ 371 Date: Mar. 20, 2006

(30) Foreign Application Priority Data
Sep. 23, 2003 (EP) 03103509.0

(51) Int. Cl. G03B 27/62

(52) U.S. Cl. 355/75; 430/5; 430/20

(57) ABSTRACT

A transparent pellicle member or plate (1) is mounted across a reticle, substantially parallel thereto, so as to define a gas-tight space (9) therebetween. The pellicle (1) is mounted on a frame (3) by flexible connection members (20) provided at opposing edges of the pellicle (1). The flexible connection members (20) may be in the form of a “bellows” type arrangement, to provide optimum flexibility in the direction perpendicular to the reticle, but significant resistance in all other directions. As a result, changes in gas pressure difference between the space (9) and the surrounding atmosphere supports the pellicle (1) using the weight of the pellicle itself. In other words, the pellicle (1) “floats” on the gas pressure difference, which pressure difference is maintained in a passive way, i.e. no electrical, pneumatic or other external connection is required.

This invention relates to a method and apparatus for protecting a reticle used in chip production from contamination and, more particularly, to a pellicle and a method of mounting such a pellicle relative to a reticle.

Patterned lithographic masks are utilised in semiconductor chip fabrication, and such lithographic masks need to be protected from particle contamination since foreign matter on a mask will produce a printed defect in the electronic circuit being created on a silicon wafer.

For current lithographic manufacture of semiconductor chips, masks are enclosed in a “pellicle” (currently 1 micrometer polyamide) to protect them from particles. The mask consists of a rigid substrate with a patterned absorbing film on one surface. A pellicle is a thin membrane, stretched over a frame mounted to the mask substrate, which prevents particles from striking patterned areas of the mask. The peilicle is offset from the mask in an “out of focus” image plane, producing a gap between the mask surface (requiring protection) and the pellicle. This offset ensures that particles intercepted by the pellicle do not produce image defects.

For the photon wavelengths used in earlier chip manufacture techniques (365 nm, 248 nm), the pellicle is highly transparent and allows the lithographic radiation to be transmitted to the mask with high efficiency. Pellicles stay affixed to the mask mounting hardware throughout the life of the mask and allow the mask to be handled and inspected free from defect-producing particle contamination.

The next generation of lithographic techniques, including 157 nm optical projection lithography, utilise ionising radiation (photons, ions and electrons, respectively) to perform lithographic imaging. Thus, the masks used in these next generation lithographic techniques are irradiated with ionising radiation during the lithographic exposure. A traditional pellicle cannot be used next generation lithography because the pellicle would absorb too much of the ionising radiation. A membrane might also degrade in the ionising beam, eventually failing and allowing the mask to become contaminated.

We have now devised an improved arrangement.

In accordance with the present invention, there is provided apparatus for protecting a reticle used in semiconductor chip fabrication from contamination, the apparatus comprising a pellicle member disposed over said reticle with a gas-tight space therebetween by connection means, characterized in that said connection means is configured to permit movement of the entire pellicle member in a direction substantially perpendicular to said reticle in response to changes in gas pressure difference between said space and the atmosphere.

Also in accordance with the present invention, there is provided a method of protecting a reticle used in semiconductor chip fabrication from contamination, the method comprising the steps of providing a pellicle member and disposing it over said reticle with a gas-tight space therebetween by connection means, characterized in that said connection means is configured to permit movement of the entire pellicle member in a direction substantially perpendicular to said reticle in response to changes in gas pressure difference between said space and the atmosphere.

Still further in accordance with the present invention, there is provided a method of fabricating a semiconductor chip, comprising the steps of providing a reticle and apparatus for protecting said reticle from contamination as defined above, providing a patterned mask on said reticle, and irradiating said reticle through the pellicle member and the mask.

Still further in accordance with the present invention, there is provided a semiconductor chip fabricated in accordance with the method defined above.

It will be appreciated that the space between the pellicle and the reticle is a closed volume filled with a gas, possibly but not necessarily air.

The connection means may comprise flexible connection members, preferably arranged to extend and contract in response to the above-mentioned changes in gas pressure differences so as to permit movement of the pellicle member in a direction perpendicular to the reticle.

In another embodiment, the connection members may comprise flexible sealing means slidably connecting the pellicle member to a support frame, such that it can move in a direction substantially perpendicular to the reticle.

In yet another embodiment, the support frame may comprise longitudinal guides in which the edges of the pellicle member are arranged to be received in a gas-tight manner. Once again, the entire pellicle member is permitted to move up and down relative to the reticle by sliding up and down the gas-tight guides.

The pellicle membrane is preferably formed of silicon glass. The reticle is preferably provided on a reticle base plate, which base plate is preferably provided with a support frame to which the pellicle member is connected.

These and other aspects of the invention will be apparent from, and elucidated with reference to, the embodiment described herein.

An embodiment of the present invention will now be described by way of example only and with reference to the accompanying drawings, in which:

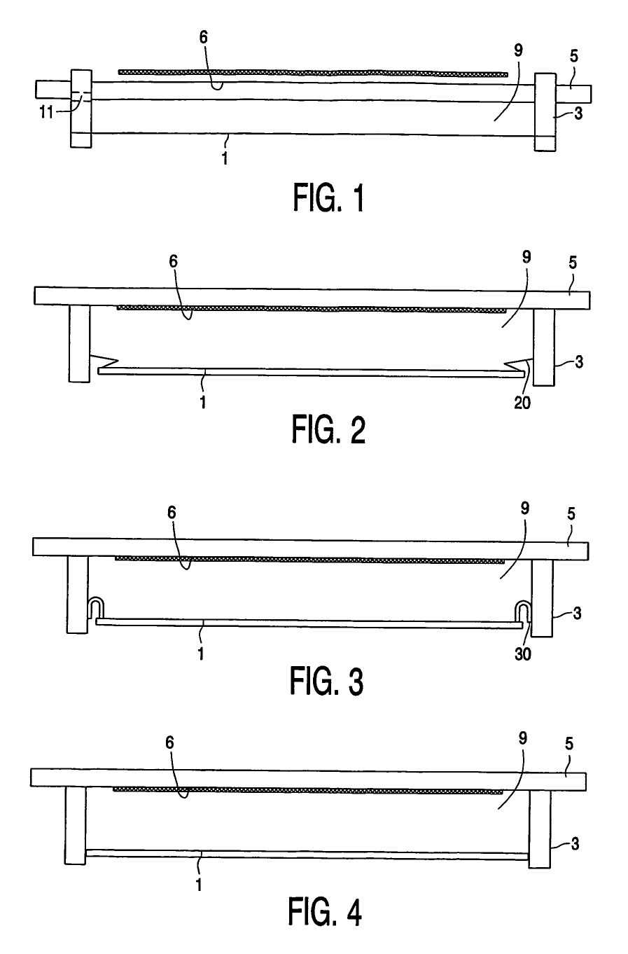

FIG. 1 is a schematic cross-sectional view of a conventional pellicle mounted on a reticle;

FIG. 2 is a schematic cross-sectional view of an arrangement according to a first exemplary embodiment of the present invention;

FIG. 3 is a schematic cross-sectional view of an arrangement according to a second exemplary embodiment of the present invention; and

FIG. 4 is a schematic cross-sectional view of an arrangement according to a third exemplary embodiment of the present invention.

Referring to FIG. 1 of the drawings, a conventional arrangement comprises a thin pellicle 1 and a frame 3. The pellicle 1 is adhered to the frame 3, and a reticle base plate 5, carrying a reticle (i.e. a photolithographic surface) on one side thereof, is adhered to the frame 3 such that there is a gap between the reticle base plate 5 and the pellicle 1. In order to equalise the pressure between the space 9 between the reticle base plate 5 and the pellicle 1, and the surrounding atmosphere, a bore hole 11 with a filter is provided in the frame 3.

Such a pellicle, as shown in FIG. 1, comprises a transparent pellicle membrane made of a highly light-transmissive material, such as 1 micrometer polyamide. A mask 6 is provided on one side of the reticle base plate 5 (over the reticle) and the reticle is then exposed to light (through the mask 6) to create the required circuit configuration on a silicium wafer.

The resolution of lithography has gradually become higher in recent years, and realise such resolution, light of a shorter wavelength has gradually come to be used as a light source. Specifically, for example, the use of a fluorine excimer laser (157 nm) is becoming increasingly desirable. However, conventional pellicle materials absorb radiation at 157 nm. Thus, the use of glass plates composed of an inorganic compound (such as silicon glass) or the like as the pellicle has been considered.

When these inorganic compounds are used as the pellicle, the pellicle should ideally have a certain thickness to give the membrane the required strength and stiffness. However, practically, the plate must be significantly thinner than that certain thickness to avoid distortion of the radiation and such a plate may become curved due to gravity force, which may cause deviation of the light path for light exposure at the pellicle surface, and thus adversely affect the light exposure.

US Patent Application No. US 2001/0004508 describes an arrangement in which the pellicle comprises a thin glass plate adhered to a frame under a photomask such that the pellicle tends to warp downwardly due to gravity. However, by decompressing the air in the space between the pellicle and the reticle, the pellicle is lifted, and hence the deformation due to gravity (and its own weight) can be relieved or eliminated.

We have now devised an improved arrangement. Referring to FIG. 2 of the drawings, an arrangement according to a first exemplary embodiment of the present invention comprises a reticle base plate 5 on one surface of which is provided a reticle (i.e. a photolithographic surface). The reticle base plate 5 is mounted on a frame 3 and a patterned mask 6 is provided on the reticle surface.

A transparent pellicle membrane or plate 1 is mounted across the reticle, substantially parallel thereto, so as to define a gas-tight space 9 therebetween. The pellicle 1 is mounted on the frame 3 by flexible connection members 20 provided at opposing edges of the pellicle 1. The flexible connection members 20 are in the form of a “bellows” type arrangement, to provide optimum flexibility in the direction perpendicular to the reticle, but significant resistance in all other directions. As a result, changes in gas pressure difference between the space 9 and the surrounding atmosphere supports the pellicle 1 (which may comprise, for example, silicon glass) using the weight of the glass pellicle itself. In other words, the pellicle 1 “floats” on the gas pressure difference, which pressure difference is maintained in a passive way, i.e. no electrical, pneumatic or other external connection is required.

Referring to FIG. 3 of the drawings, an arrangement according to a second exemplary embodiment of the invention comprises many of the same features as that described with reference to FIG. 2, and like reference numbers are used to denote corresponding features. However, in this case, the connection members 30 comprise flexible sealing means which are connected to the frame 3 and configured to slide relative thereto in a direction perpendicular to the reticle. Such that the entire pellicle 1 can move up and down relative to the reticle, as described with reference to FIG. 2. In an alternative embodiment, the U-shaped flexible connection members 30 are fixed to the frame 3, whereby as the pellicle moves up and down the members 30 “roll” from one “leg” of the U-shape to the other.

Referring to FIG. 4 of the drawings, an arrangement according to a third exemplary embodiment of the invention again comprises many of the same features as those described with reference to FIGS. 2 and 3, and like reference numbers are once again used to denote corresponding features. However, in this case, a longitudinal guide (not shown) is provided on the sides of the frame 3, within which guides the pellicle 1 is able to slide in a direction perpendicular to the reticle, such that once again, the changes in gas pressure difference inside the reticle arrangement relative atmospheric pressure supports the pellicle 1 using its own weight.

In the case where the pellicle membrane is rectangular in shape, it may be difficult to obtain a flexible connection between the pellicle and the support frame. In such a case, a radius may be used at the corners of the pellicle membrane.

It should be noted that the above-mentioned embodiment illustrates rather than limits the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. In a device claim enumerating several means, several of these means may be embodied by one and the same item of hardware. The mere fact that certain measures are recited in mutually different dependent claims does not indicate that a combination of these measures cannot be used to advantage.

1. Apparatus for protecting a reticle used in semiconductor chip fabrication from contamination, the apparatus comprising a pellicle member (1) disposed over said reticle with a gas-tight space (9) therebetween by connection means (20,30), characterized in that said connection means (20,30) is configured to permit movement of the entire pellicle member (1) in a direction substantially perpendicular to said reticle in response to changes in gas pressure difference between said space (9) and the atmosphere.

2. Apparatus according to claim 1, wherein said connection means comprises flexible connection members (20).

3. Apparatus according to claim 2, wherein said connection members (20) are arranged to extend and contract in response to said changes in gas pressure difference so as to permit movement of the pellicle member (1) in a direction perpendicular to the reticle.

4. Apparatus according to claim 1, wherein said connection means comprise flexible sealing means (30) slidably connecting the pellicle member (1) to a support frame (3) such that it can move in a direction substantially perpendicular to the reticle.

5. Apparatus according to claim 1, further comprising a support frame (3) including longitudinal guides in which the edges of the pellicle member (1) are arranged to be received in a gas-tight manner.

6. Apparatus according to claim 1, wherein the pellicle member (1) is formed of silicon glass.

7. Apparatus according to claim 1 wherein the reticle is provided on a reticle base plate (5), which base plate (5) is provided with a support frame (3) to which the pellicle member (1) is connected.

8. A method of protecting a reticle used in semiconductor chip fabrication from contamination, the method comprising the steps of providing a pellicle member (1) and disposing it over said reticle with a gas-tight space (9) therebetween by connection means (20,30), characterized in that said connections means (20,30) is configured to permit movement of the entire pellicle member (1) in a direction substantially perpendicular to said reticle in response to changes in gas pressure difference between said space (9) and the atmosphere.

9. A method of fabricating a semiconductor chip, comprising the steps of providing a reticle and apparatus for protecting said reticle from contamination according to claim 1, providing a patterned mask (6) on said reticle, and irradiating said reticle through the pellicle member (1) and the mask (6).

10. A semiconductor chip fabricated in accordance with the method of claim 9.
